(19) United States
(12) Patent Application Publication
(10) Pub. No.: US 2026/0183960 A1
(43) Pub. Date: Jul. 2, 2026

(54) ROBOTICS CONTAINER SYSTEM (RCS)

(71) Applicant: George Moser, Fuquay Varina, NC (US)

(72) Inventor: George Moser, Fuquay Varina, NC (US)

(21) Appl. No.: 19/546,397

(22) Filed: Feb. 22, 2026

Related U.S. Application Data
(62) Division of application No. 18/964,316, filed on Nov. 29, 2024.

(51) Int. Cl. B25J 9/16; B65D 90/00

(52) U.S. Cl. CPC B25J 9/1687; B25J 9/1638; B25J 9/1666; B65D 90/0073; B65D 90/0086

(57) ABSTRACT

The invention relates to the field of logistics and robotics. It turns a passive container into an active, smart container that uses advanced Robotics to create major new efficiencies and major cost reductions in the supply chains of the world including ecommerce. Traditional prior art containers made valuable contributions to the efficiency of port operations by loading cargo ships about 20 times faster than before, but they didn't address the issue of emptying the container in a specific order when it arrives at its final destination, which is still an inefficient and expensive manual process. The present invention resolves that issues, because the new active smart container can unload itself automatically. This invention applies that new capability to ecommerce with substantial advantages, but the field of application includes many other areas of logistics as well.

The present invention is a continuation-in-part of prior pending U.S. patent application Ser. No. 18/161,050, filed on Jan. 28, 2023, titled ROBOT LOGISTICS SYSTEM, the entire contents of which are incorporated herein by reference.

### 1. FIELD OF THE INVENTION

The present invention relates to the field of logistics and robotics.

### 2. PRIOR ART

The prior art includes an American invention that was revolutionary and literally changed the world at its time, and that today has become a standard for the shipping industry: the shipping Container. About 90% of cargo shipping worldwide today relies on containers.

The inventor of the original container shipping system was American entrepreneur and inventor Malcolm McLean from North Carolina, who was granted U.S. Pat. No. 2,853,968, Priority Date 1958-09-30. His invention was focused on the modifications that needed to be made to ships to be able to receive and securely hold containers. In particular this patent heavily focuses on using already existing ships, primarily oil tankers which were underutilized at that time since the end of the second world war. Oil tankers were not suitable for shipping general cargo because their decks were crowded with pipes, fixtures and other structures, and oil tankers had to return empty after delivering their oil. McLean proposed transforming single use vessels, typically oil tankers, into dual purpose vessels (both oil and general cargo) using his container concept. His concept was basically to create special structures he called seats in the main deck of the tanker ships. The containers are then deposited by land-based cranes into the seats. The seats define the correct positions and securely hold the containers in place during the voyage. He also proposed the arrangement of containers in longitudinal rows along the ship, which is still in use today.

FIG. 1 shows a typical container ship built along the teachings of the McLean patent with a very large number of containers.

FIG. 2. shows a typical prior art container including the following components:
a frame made out of steel beams such as 21, 22, 23, 24, 25, 26 and 27,
three walls made out of corrugated sheet metal such as 28,
doors such as 29, and
a roof such as 20, typically also made of corrugated sheet metal.

The corrugated sheet metal for the walls is typically made by running flat sheet metal plates through a machine with steel wheels that compress and deforms the plates, creating channels that greatly increase the stiffness and the strength of the walls. The roof and the floor of the container are typically made out of sheet metal plates that can be corrugated or stamped to create a series of peaks and valleys that increase stiffness and strength.

The manufacture of containers involves a large amount of welding. The walls are welded to the top beams and to the bottom beams. The floor is welded to the bottom beams. The roof is welded to the top beams.

The engineering design provides enough strength and stiffness that the whole loaded container can be lifted by a crane from four points, typically from rings located at the top four corners of the framework, in order to lift it from the loading dock at the port and deposit it into the container ship, without the container suffering permanent deformation in the operation, despite the considerable length of containers (typically 20 ft, 40 ft or even longer).

FIG. 3 shows a typical prior art container with its front doors open to show the inside of the container, which is empty and completely available for storing cargo inside. The floor 31 is typically made of stamped sheet metal and covered inside with marine-grade plywood or bamboo, coated with a sealant. This type of container is often of the type designated as Dry Container, which means that once the doors are closed, it is hermetically sealed and impervious to water and salt.

FIG. 4 shows a prior art modification of the standard container: the container with removable roof. It is used for special cases, such as bulk loading of grain or other bulk goods into this special container. The roof is not welded to the container, but just attached to it with fasteners. As shown in FIG. 4, the roof 41 is removed and deposited on the floor, while the bulk filling of the container is performed. It is used only for special cases cases, because it has some substantial disadvantages:
removing a large structure like the roof is not a simple operation, it requires special equipment not always available at the container filling station
Roof removal requires time and is potentially dangerous to workers
In busy loading or unloading areas it can be difficult to find the space to temporarily store such a large structure
The removed roof can easily be damaged during removal or on the ground by other vehicles or other containers
The re-installation of the roof requires time, special equipment and special training
The removed roof can slightly deform by minor impact or stress during removal, and it becomes difficult or impossible to re-install, delaying the whole operation. As a result of those minor deformations, the roof may also become specific to one container only and will not fit other containers. That requires a trackability system for each roof removed.
After re-installation, the roof can leak, ruining the contents of the container.

Because of the above disadvantages the vast majority of containers today are of the fixed, welded roof type.

McLean's invention was extremely successful, because it dramatically reduced the time needed to load cargo ships. Prior to the invention of the container, cargo ships were immobilized for a long time at ports while the cargo was being loaded. A ship makes money only when it is traveling at sea, immobilized at port it just makes losses. The cargo used to arrive at the port by truck and railway as millions of individual pieces, in form of barrels, boxes and bags which all had to be manually identified, sorted and loaded. This was a very expensive, error-prone and time-consuming manual labor process, with high secondary costs due to breakage, loss and pilferage. Losses were common (“lost in shipping”) which made arrival of purchased goods unpredictable. By contrast, the new container system can load a giant container ship in a matter of hours with very high accuracy. It is approximately 20 times faster than the previous manual system, with minimal secondary costs because containers arrive sealed and ready to load. In addition, containers lead to more compact and efficient loading, which substantially increases the total payload of the ship.

McLean was inducted into the National Inventors Hall of Fame and is recognized as the father of the container, which has made transportation faster, more cost-effective, safer and more predictable.
U.S. Pat. 2,985,131A by G. Knight, Priority date 1959-03-24, discloses several design methods to convert oil tankers into container ships.
US Pub 2013/0233755A1 discloses a plastic molded container with external rigidizing metal members around it (exoskeleton). The main object of this invention is to reduce weight by primarily using plastics instead of metal. Another object is to create radio frequency permeability (RF waves can easily cross plastic walls, but can be blocked by metal walls), so that communication devices can be installed inside the container for trackability. While the idea is interesting, it is not used in practice because of manufacturing difficulties, fragility of the plastic walls, aging of the plastic under marine conditions and sun exposure and potential reliability issues.
U.S. Pat. No. 3,570,698 discloses a collapsible container that can save space when not in use. The complexity makes the manufacturing of collapsible containers very challenging, not implemented in practice.
U.S. Pat. No. 4,214,669 discloses another collapsible cargo container.
U.S. Pat. No. 5,190,179 discloses another collapsible cargo container.
U.S. Pat. No. 7,002,472 discloses a cargo container with electronic security devices.
U.S. Pat. No. 7,714,708 B2 discloses a cargo container with electronic devices to improve both trackability and intrusion detection.

### 3. ADVANTAGES OF THE PRESENT INVENTION

While the shipping container is undoubtedly a great invention and a great product, it also has some important shortcomings:
The container resolved the issue of inefficient loading of the ships at port, but it does not address the issue of inefficient filling of the container itself BEFORE shipping it to the port by truck, train or other means. Goods to be shipped still have to be manually loaded by manufacturers, distributors and sellers into containers before sending the containers to the port. That is an operation that can be dramatically improved by the present invention. That shortcoming has not been addressed by the prior art.
Another major shortcoming of the prior art container is the inefficiency and high cost of extracting the goods from the container AFTER it arrives at its final destination in a voyage that typically includes a sea trip and subsequently a ground trip by truck or railway to the final destination. The final destination can be a manufacturer, a store, a distribution center or similar. At that final destination, the goods need to be physically extracted from the container, identified, sorted and inventoried. All of that is currently done manually at high cost. That shortcoming has not been addressed by the prior art.

The present invention addresses the shortcomings of the prior art container in a novel, pragmatic and cost-effective way, increasing the efficiency of the whole operation, not just the port operations. That is important, because the total cost of shipping actually includes not only the loading into the ship at the seaport, but also the filling of the container before sending it to the seaport, and also the emptying of the container after arrival at the final destination.

The present invention turns a passive, “dumb” container into an active, smart container that uses advanced Robotics and Artificial Intelligence to create major new efficiencies and major cost reductions in the supply chains of the world. We call it the Robotic Container System (RCS), the next generation in Logistics, described in detail hereinafter.

The next generation Container is not only a major efficiency and cost reduction tool. It can also be used to facilitate, enrich and upgrade the jobs of human workers, contributing to higher job satisfaction, retention, enhanced safety, loyalty and harmony, which translates not only into better financial outcomes but also into a positive reputation and good-will for the company as a good corporate citizen.

### 5. LIST OF FIGURES

FIG. 1 shows a container shipped loaded with a large number of traditional containers.

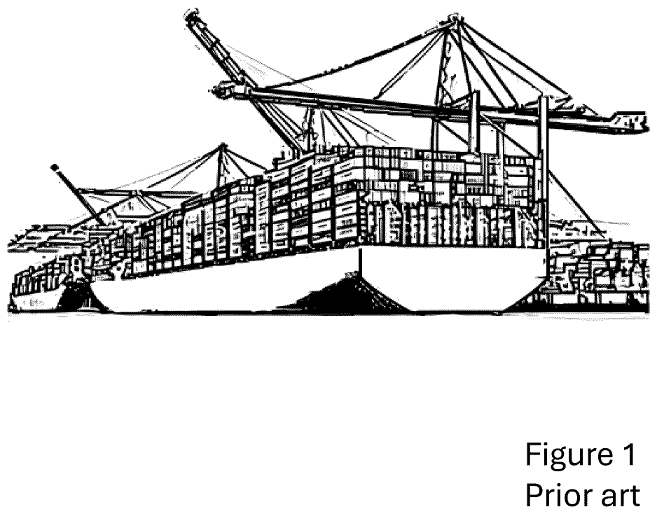

FIG. 2 is a rear view of a prior art cargo container with closed doors.

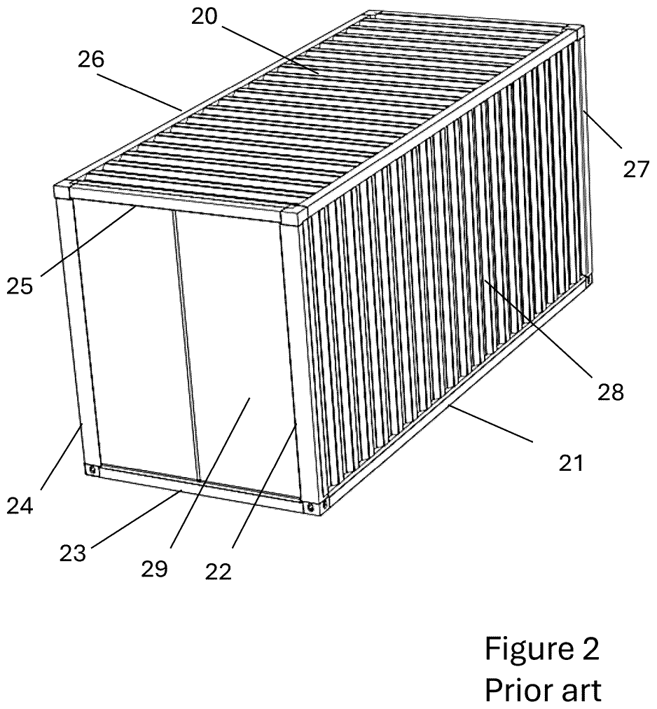

FIG. 3 is a rear view of a prior art cargo container with open doors, showing the empty inside of the container.

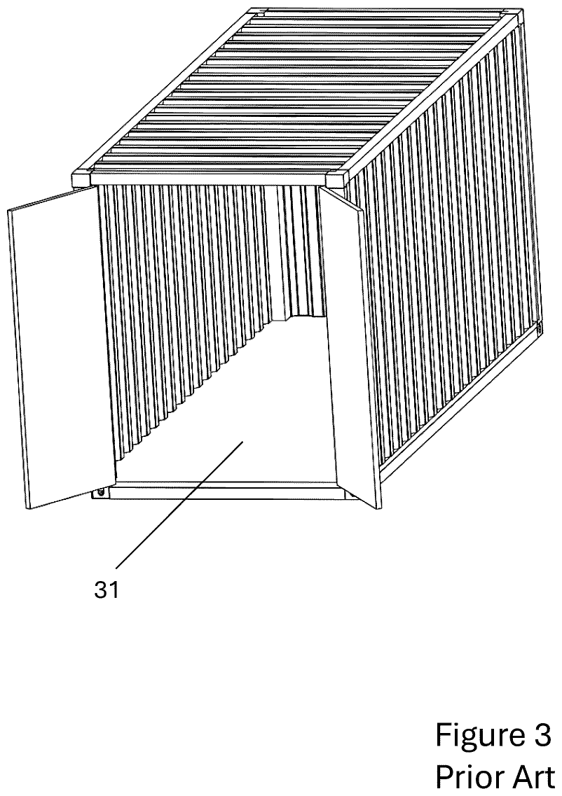

FIG. 4 shows a prior art container with the complete roof removed and stored on the ground near the container.

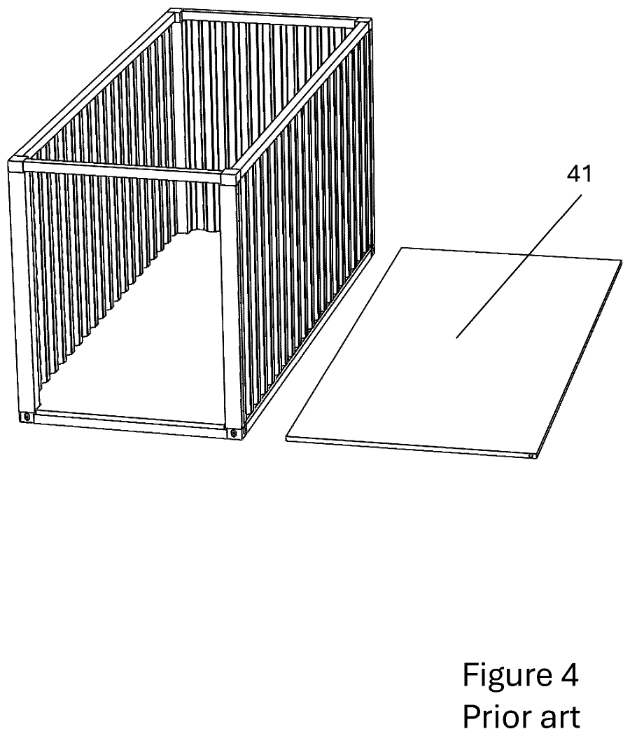

FIG. 5 is a top view of a container with a double roof in closed position.

FIG. 6 is a top view of a container with a double roof in partially open position.

FIG. 7 is a top view of a double roof container in fully open position.

FIG. 8 shows a container with a single roof in partially open position.

FIG. 9 shows a container with a single roof in fully open position.

FIG. 10 shows a mechanism that can be used to automatically open the roof of a container.

FIG. 11 shows a prior art cartesian robot with its robotic arm (Z) in resting position.

FIG. 12 shows a prior art cartesian robot deploying its robotic arm (Z) downwards to grab an object.

FIG. 13 shows a prior art cartesian robot with its robotic arm (Z) retracting upwards in order to lift an object.

FIG. 14 shows the novel cartesian robot of this invention in retracted mode.

FIG. 15 shows details of the structure and mechanisms of the novel cartesian robot of this invention.

FIG. 16 shows the novel cartesian robot of this invention in extended mode to grab an object.

FIG. 17 shows an alternative embodiment of the onboard robot

FIG. 18 shows another alternative embodiment of the onboard robot

FIG. 19 shows the new active, smart automated Container with its built-in novel extendable cartesian robot.

FIG. 20 shows the new active, smart automated Container with its built-in novel extendable cartesian robot and its internal partition system to organize the cargo.

FIG. 21 is a top view of the new active, smart automated Container with its built-in cartesian robot and its internal partition system to organize the cargo.

FIG. 22 shows a side view of the new active, smart automated Container with its built-in cartesian robot, its internal partition system, and a sliding side door to provide access to selected cargo picked by the cartesian robot and deposited on a bench near the door waiting to be picked by outside personnel or by delivery robots or delivery drones.

FIG. 23 shows a side view of the new active, smart automated Container with its built-in cartesian robot, its internal partition system to organize the cargo and a side door to provide access to the picked cargo which is placed by the robot on a dispensing conveyor belt for easy access to it by outside personnel or other robots.

FIG. 24 shows the new active, smart automated Container with a dispensing conveyor belt which can protrude out of the container as needed in order to automatically deliver its picked cargo to a warehouse conveyor belt, thereby integrating the smart active Container with the warehouse system or even directly with a production line.

FIG. 25 shows the new active smart Container system which is also equipped with a refrigeration unit for perishable products, such as pharmaceuticals, chemicals, food and beverage items and others.

FIG. 26 shows a Robotic Container System (RCS), consisting of a flatbed truck carrying a smart active Container, a configuration that is ideal for ground shipping cargo in general and also especially for e-commerce delivery.

FIG. 27 shows the passenger side of the RCS flatbed truck, with an access door where the internal cartesian robot deposits objects on a conveyor belt that brings the objects close to outside personnel, delivery robot or delivery drone.

FIG. 28 shows the E-RCS, an electric-powered truck with an active, smart Robotic Container System, which is an ideal configuration for ecommerce delivery.

### 6. DESCRIPTION OF THE INVENTION

It is well known in the logistics field that so-called overhead operations are almost always substantially more efficient and faster than ground operations. They are usually easier to automate and require less labor. Overhead operations are logistics operations that rely primarily on cranes and similar equipment to load and unload cargo. That explains why the McLean container was so efficient and successful when used to load containers into ships at the port: the crane lifts the whole container, which may contain about 200,000 items, and transfers all of them in one simple, quick overhead operation to the ship—as opposed to handling hundreds of thousands of items individually, one by one.

In overhead operations, items basically travel through the air carried by cranes, with minimal need for labor (labor needed only to operate the cranes and secure the containers in their seats in the ship with quick fasteners).

The loading of the ship with containers is an overhead operation, hence extremely efficient.

The loading of goods into a prior art container BEFORE sending it to the seaport is a ground operation. Workers open the doors of the container and manually carry the goods into the container (heavy goods by forklift) and try to organize them according to their intuition in the most favorable arrangement inside the container. That is hard to do. Intuition of the workers cannot really optimize the arrangement of goods inside the container to maximize capacity and also achieve some weight balance in the cargo, because workers don't know what comes next. The whole process is slow, inefficient and expensive.

The off-loading of goods from the container AFTER arrival at the final destination is also a ground Operation, also inefficient and costly. Workers have to go inside the container, manually pick up the goods, carry them out of the container, inspect for damage, sort them and inventory them - a manual, labor intensive, inefficient process.

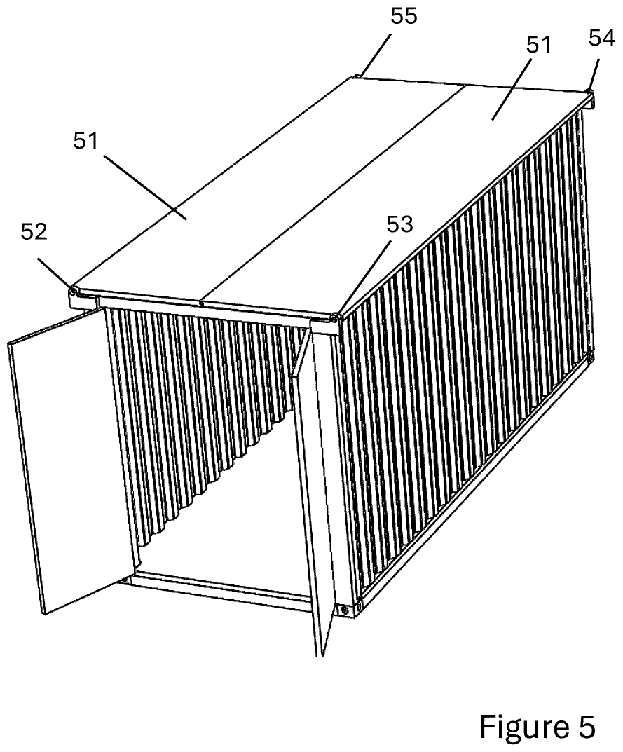

The traditional container normally allows loading and offloading of the container only through its door(s), which is fundamentally a ground operation. There are no provisions for an overhead operation such as loading and off-loading through the roof, because the roof is welded to the container. One exception is the containers with fully removable roof, which are very seldom used and only for bulk goods, because they are impractical and problematic for the reasons described above under prior art. The first step to achieving a new generation of ultra-efficient containers is to create a container that supports Overhead Operations easily and reliably. Such a novel container is shown in FIG. 5.

FIG. 5 shows a novel container with a double roof 51 attached to the frame of the container by hinges 52, 53, 54 and 55. A double roof is a roof that consists of two sections, as shown in this Figure.

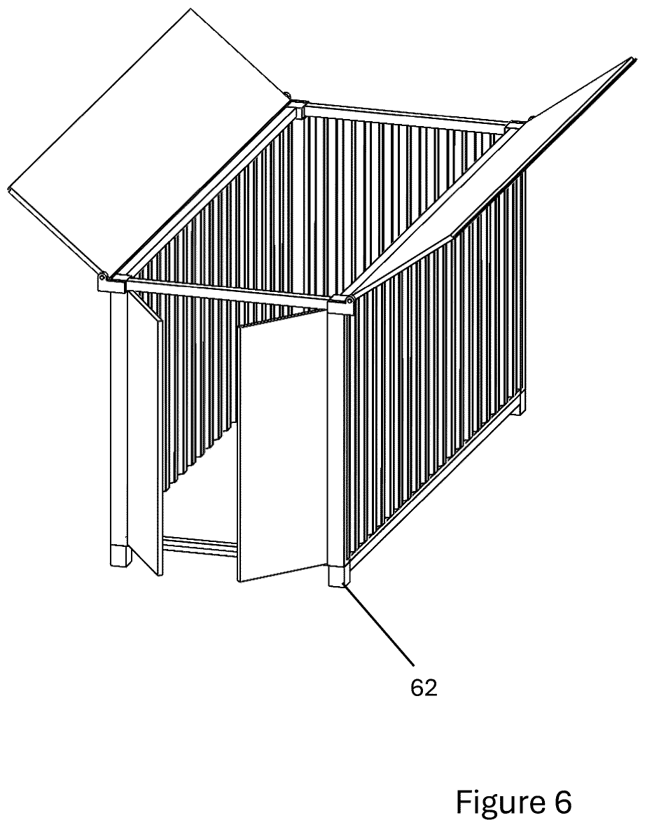

FIG. 6 shows the container roof partially open. The capability of the container to open and close its roof is an important feature, because it enables overhead operations with cranes, which tend to be very efficient and easier to automate.

FIG. 6 also shows the feet 62 which are blocks that the container rests on. The purpose of this optional feature is to create a small clearance from the ground, so that small traction robots can crawl under the container, lift it a small distance so that the whole container including the feet clear the round, and then move it to any desired location. The traction robots therefore turn the container into a mobile container, without the need for a forklift or a crane. This feature can be very valuable inside a warehouse or distribution center, where the container can be sent to any desired location in the warehouse without requiring human labor or additional equipment other than the traction robots. Of course, the container can also be transported by an overhead crane, but that is not always available for all locations, so the feet can be very helpful in many situations, especially when operating inside a warehouse.

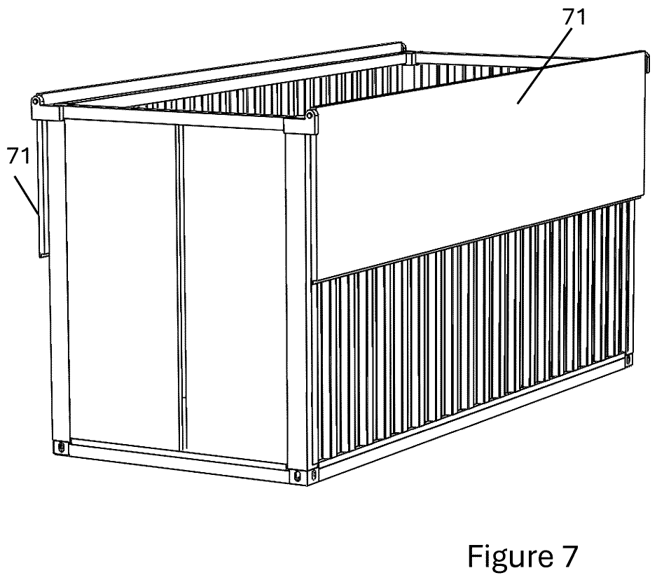

FIG. 7 shows the container fully open, with the roof 71 hanging from the hinges in a position that is approximately parallel to the side walls of the container. To reach that position the hinges have to allow a rotation angle of about 270 degrees or more. When fully open, the roof sections are secured by quick fasteners located near the lower edge of the folded roof sections (not depicted to keep the drawing simple) to the container body to maintain a constant position of the roof sections substantially parallel to the walls, in order to avoid damage or injury to workers or to other equipment if the container is moved while the roof is open. The whole container can be easily lifted and moved by cranes with its roof fully open if necessary. This type of roof has the advantage that it remains attached to the container at all times, without experiencing the deformation or damage that can easily happen if the roof is removed and separated from the container, creating storage issues for the separated roofs and more congestion in a typically already congested loading area because of the considerable size of the roof. A reattachment operation is not necessary, the roof remains safely attached. Opening and closing the roof requires minimal or no labor, therefore this is a very efficient approach. Ensuring a watertight seal can be relatively easily achieved with state-of-the-art solutions like gaskets and O-rings.

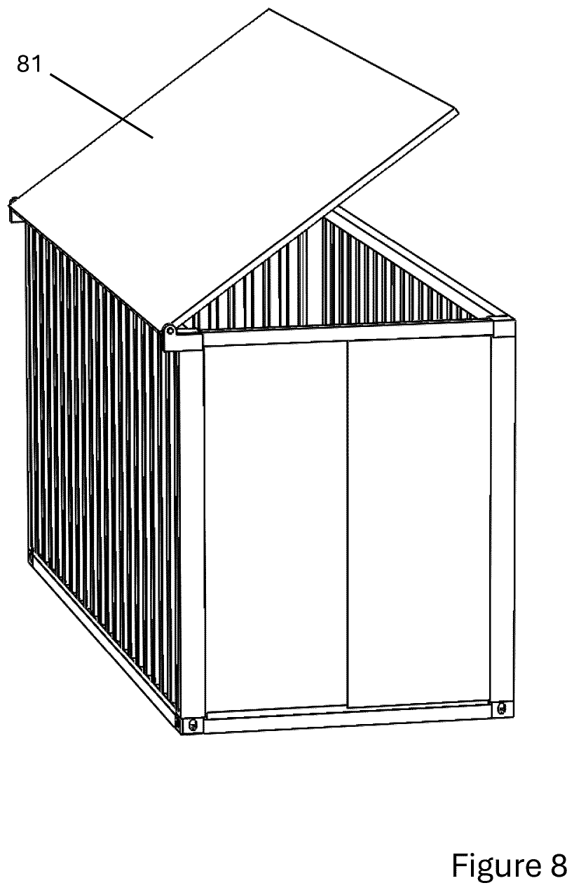

FIG. 8 shows a partially open single roof 81. A single roof is a roof made of only one section (as opposed to a double roof with two sections). This embodiment has the disadvantage compared to a double roof described above that it requires a stronger and stiffer structure for the roof and a more powerful actuation system if the opening and closing is automated. It has the advantage of a very simple sealing system with a gasket or O-ring between door and frame. Both options (single or double roof) are very viable.

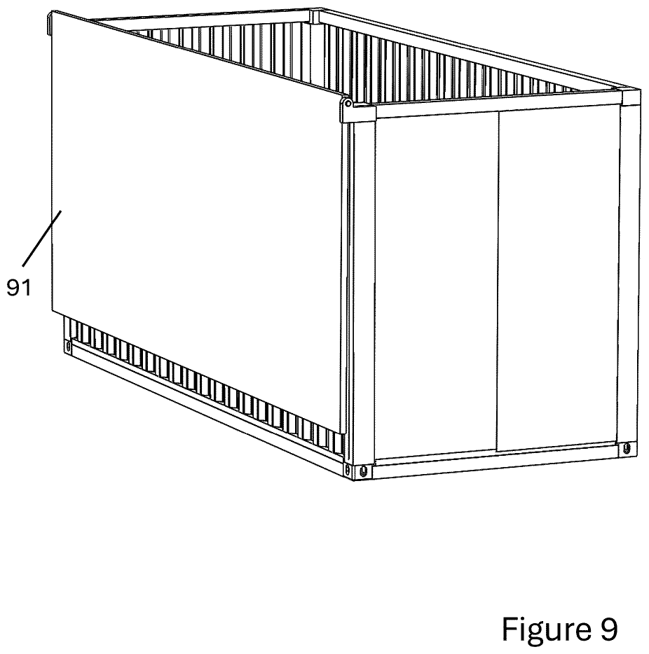

FIG. 9 shows the single roof 91 folded open alongside a wall of the container.

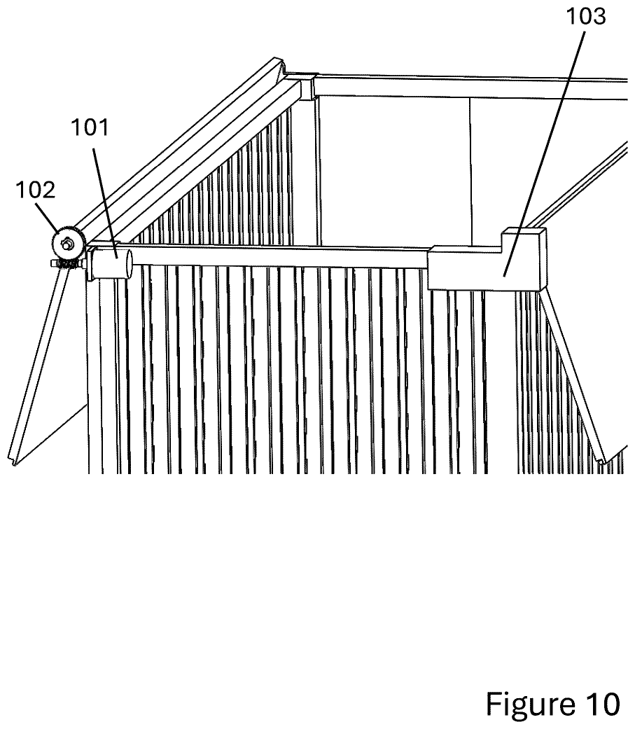

FIG. 10 shows that the opening and closing of the roof can be motorized, which constitutes a very convenient, economical, quick and safe way to provide an open roof when needed. There are many possible ways to automate the roof for both a single roof and a double roof. One of the many possibilities is shown in FIG. 10, which includes an electric motor 101 driving a worm gear mechanism 102. The right side of FIG. 10 shows the external protective case 103 that houses the whole mechanism, which is necessary for worker safety and to protect the mechanism from the elements.

Another option to open and close the roof is by providing attachment rings or other engagement features (not depicted) on the roof, which can be used by a crane with a cable or chain to pull and rotate the roof or roof sections upwards, and then softly release said cable to let the roof of roof sections fold down alongside the side walls of the container. The securing mechanism can be an automatic engagement quick-connect mechanism.

The big advantage of a mechanism to open and close the roof is that such a system greatly facilitates automating the loading and off-loading of goods into and from the container. Electric signals to open or close the roof can be generated by the Electronic Controller or computer described below.

There are multiple ways to open and secure the doors, including different hinges, different locations for the hinges and different quick fasteners to secure the doors in an open or closed position. The embodiments shown above represent just some of the many possible embodiments of the invention. It is also conceivable to use a slidable approach with either a double roof or a single roof. There are also many other options to automate the opening and closing of the roof. A person versed in the art can conceive and design many other alternatives, which would all fall within the scope of the invention.

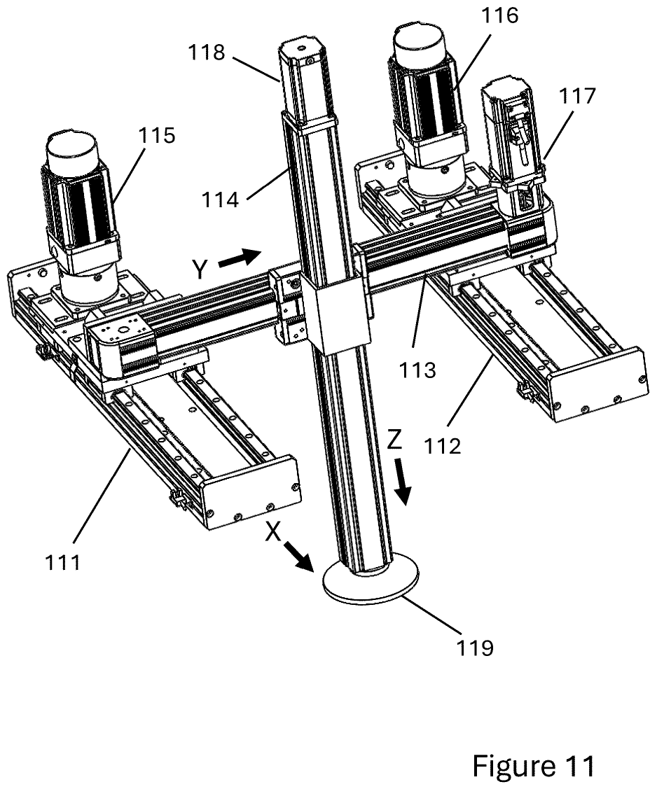

The present invention provides an active smart Container, as opposed to prior art passive “dumb” containers which are just boxes without any functionality or intelligence. To achieve that a robot has to be integrated into the Container. Many different types of robots can be used, including a robot arm mounted on a platform inside the container. The problem with most robots inside a container is the amount of space they need for attachment and for operation, which can reduce the amount of space available for cargo, which needs to be maximized for cost efficiency. Our preferred embodiment includes a type of robot called a Cartesian Robot, as shown in FIG. 11. Cartesian Robots are well known in industry because of their very high accuracy, speed, relative simplicity and durability.

FIG. 11 shows a prior art Cartesian Robot, which basically consists of two horizontal parallel rails 111 and 112, which act as sliding supports for the bridge 113. The bridge can move back and forth sliding along the rails, which define the X axis, the first degree of freedom of the robot.

The vertical robotic arm 114 is a rigid steel member with a rectangular cross-section slidably mounted on the bridge. It can move back and forth between the rails, which defines the second degree of freedom of the robot, the Y axis.

The arm 114 can also move up and down with respect to the bridge, which defines the third degree of freedom, the Z axis. The arm has a suction cup mechanism 119 at the end of the arm, which can be used to pick and lift objects such as packages by creating a vacuum between the cup and the object. Instead of a suction cup it is also possible to use a gripper for certain objects if needed.

There are 4 motors that control the position of the suction cup at all times. The electric motors 115 and 116, which are perfectly synchronized with each other, move the bridge along the rails (the X axis). The electric motor 117 moves the arm 114 back and forth between the rails (Y axis). The electric motor 118 moves the arm 114 vertically up and down (Z axis).

By combining the action of the 4 motors, which are managed by an electronic robot controller in the container, the robotic arm can be positioned in any 3D point with any coordinates X, Y, Z within the workspace of the robot. That can be used to pick up objects from any point and transfer them to any point, with very high accuracy, speed and repeatability.

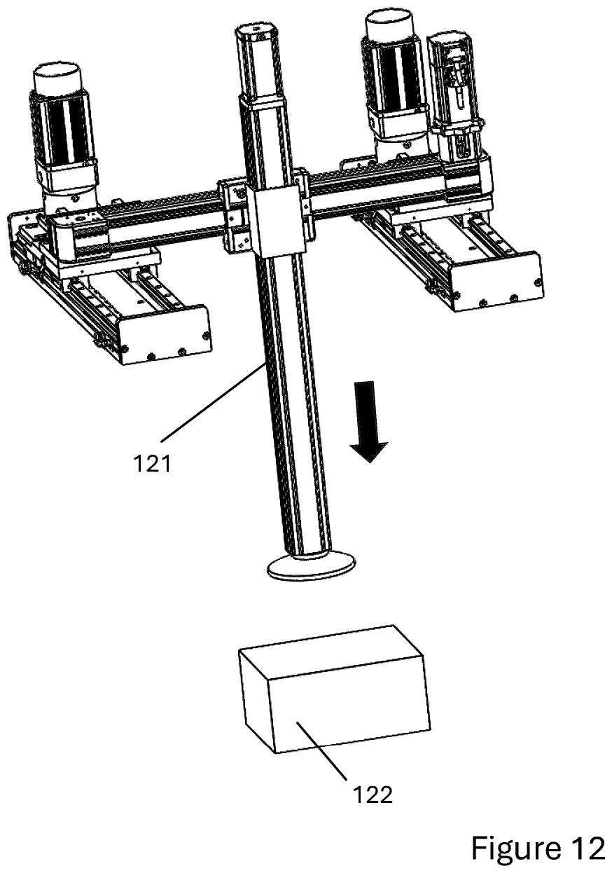

FIG. 12 shows the cartesian robot lowering its arm 121 in order to pick up object 122.

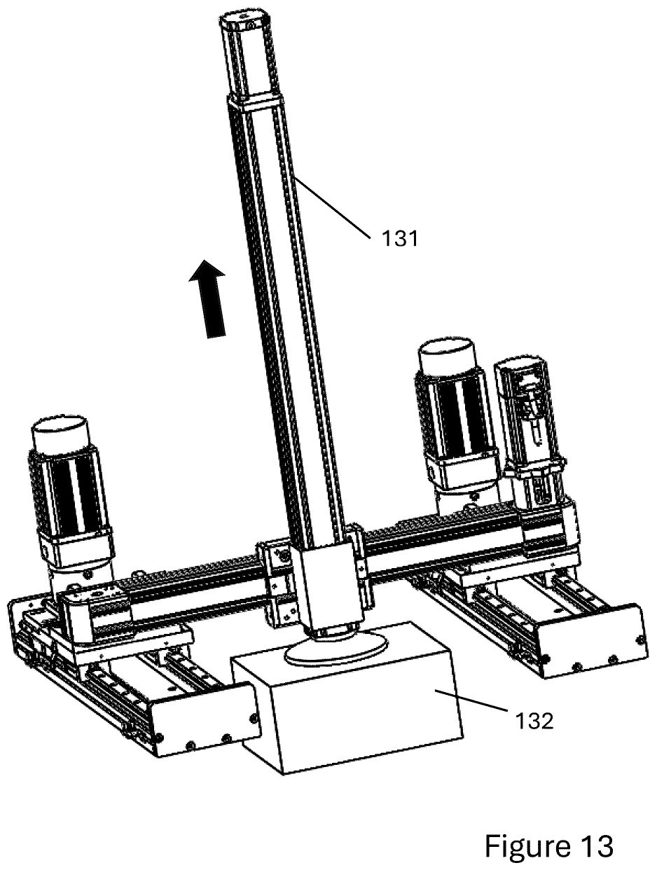

FIG. 13 shows the Cartesian Robot lifting its arm 131 upwards to raise the object 132 being held by the suction cup. This figure illustrates a limitation of conventional Cartesian Robots: the arm extends upwards and protrudes up a long distance when lifting objects. That creates a problem in some cases, because the top of the arm can clash with the roof of the work cell, factory or warehouse (unless the roof of the facility is high enough to prevent that from happening).

FIG. 13 actually understates this issue, because it shows an arm which is much shorter than what is typically needed for logistics applications, which will typically need a much longer arm to pick up objects (about 2 to 4 times as long as shown in FIG. 13).

For a Cartesian robot installed inside a container, this issue would be almost impossible to overcome, because the arm would clash with the roof of the container, unless a) the roof of the container is opened before operating the robot, which the container electronic controller can take care of, disabling the robot whenever the container roof is closed, and b) the roof of the facility is high enough to prevent the robot arm to clash with the roof of the facility, because the arm will protrude a long height out of the container. For mobile applications such as ecommerce delivery of packages the cartesian robot would inevitably clash with the roof of the delivery vehicle, or if the vehicle is an open truck carrying a container, it would clash with the container roof. Even if the container had an open roof, the robot arm would protrude too long out of the vehicle during retraction, interfering with overpasses, bridges, power lines, signs and other obstacles.

Another possible approach to avoid clashes is to reduce the stroke needed to retrieve items from the container, by using a different storing strategy inside the container: instead of vertically stacking items, which typically requires long strokes for the robot, a strategy based on lifting devices, rising floor, circulating conveyor belts or other approaches can be used to reduce the stroke. However, those alternative strategies create complexity, higher cost, reliability issues and use up substantial space inside the container, so they are usually impractical.

Therefore, we developed and successfully tested a novel type of Cartesian robot that can provide a very long stroke without any possibility of a clash during retraction.

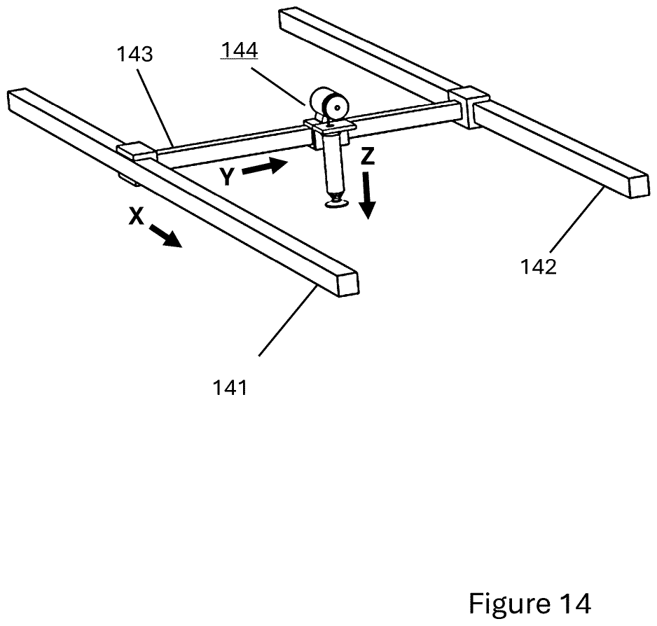

FIG. 14 is a simplified drawing showing a novel type of Cartesian Robot, which has major advantages for any application that requires lifting objects a substantial distance, including but not limited to Logistics. We call it the Extendable Cartesian Robot.

The propulsion motors of the robot are not shown in FIG. 14 to avoid clutter in the drawing. The motors and their positions can be the same as in a prior art Cartesian robot, so there is no need to include them in FIG. 14.

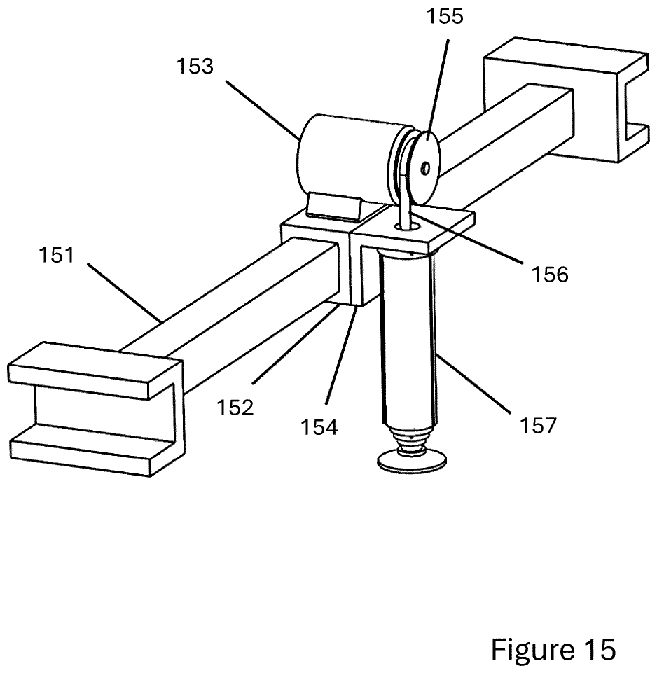

FIG. 14 shows the parallel rails 141 and 142 which serve as sliding guides for the bridge 143 defining the X axis. The Extension Mechanism 144 includes a motor, a pulley, a traction belt, a deployable actuator and a suction cup at the end of the actuator. It is described in more detail in FIG. 15.

FIG. 15 is used to describe in detail the Extension Mechanism of this invention. The slider 152 wraps around the bridge and can slidably move back and forth between the two rails (omitted in this Figure), carrying the electric motor 153 which is mounted on top of the slider. The flange 154 is attached to the front of the slider. An extendable and retractable actuator 157 is attached to the flange in a hanging position. The actuator 157 consists of a set of concentric cylinders that can slide up or down with respect to each other to achieve deployment or retraction of the actuator, with a set of internal stops limiting the stroke of each cylinder and maintaining the whole set together. A pulley 155 is mounted on the motor shaft. A flat belt 156 is wrapped around the pulley, with one end attached to the pulley and the other end penetrating into the actuator through an orifice in the flange and attaching to the lowest cylinder in the actuator. If the motor turns counterclockwise, the pulley will rotate and the belt will partly unwrap from the pulley, allowing the lowest actuator to descend by force of gravity. Because of the internal stops, the actuator will sequentially extend all its cylinders, moving the suction cup down. Once the target object is reached and engaged by the cup, the motor reverses rotation direction, causing the actuator to sequentially pull in its cylinders, retracting the actuator along with the object to be lifted.

The extendable actuator 157 based on multiple concentric metal cylinders with its top cylinder rigidly attached to the robot through flange 154, plays an important role in this invention. Without this actuator, the belt 156 would be unconstrained and it would start swinging back and forth along with the object to be lifted, which could cause injury to workers and damage to the object or to the machinery and other property. That danger is avoided by the actuator, which is extendable, but not bendable, and therefore restricts the belt, keeping it always vertical and perpendicular to the floor, preventing any swinging movements.

Without the actuator, the belt would be swinging back and forth like a pendulum along with the object being lifted. The swinging movements of the belt could be reduced by allowing the cartesian robot to move only very slowly, but that is not a real possibility, because that limitation would negate the efficiency of the system. Cartesian robots are effective because they can move fast.

The actuator of this invention works preferably by gravity in its descent and by the power of the electric motor 153 in its retraction.

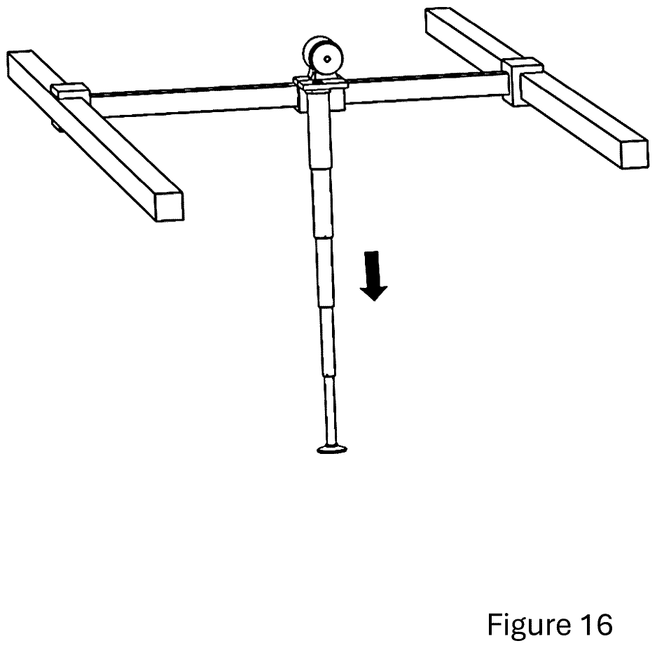

FIG. 16 shows the Extendable Cartesian Robot with its concentric-tube actuator extended downwards.

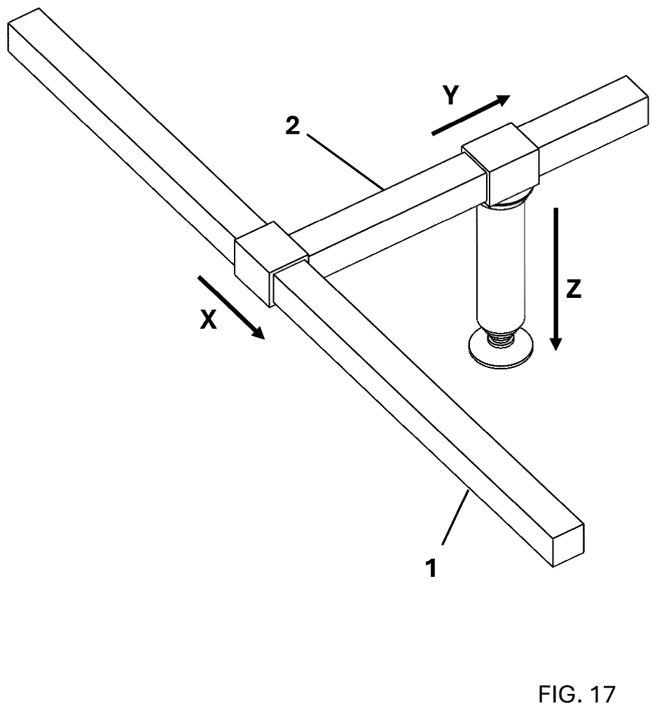

FIG. 17 shows a different embodiment of the invention, with a different type of robot that can also provide an extended stroke to reach an object without causing interference or clashing with a roof or other overhead structures when retracted. This robot has a rail 1 (X axis), which serves as sliding support and guide for cantilever beam 2 (Y axis). The extension mechanism (Z axis) hangs from rail 2, providing the extended stroke.

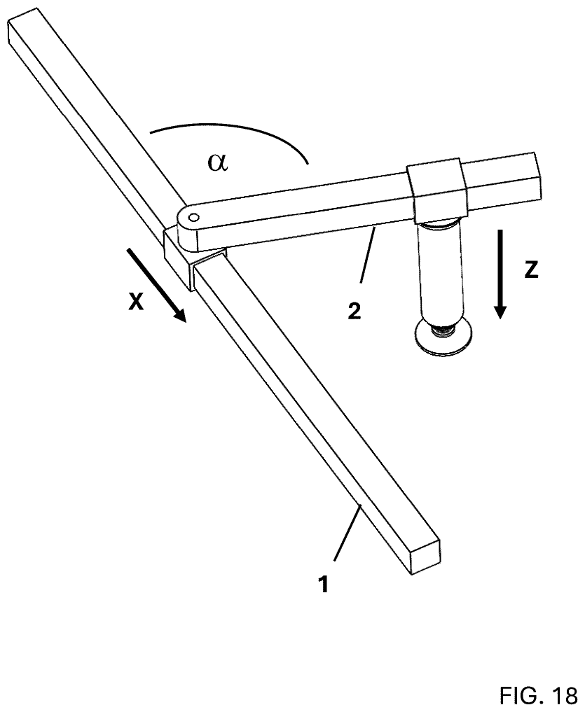

FIG. 18 shows another different embodiment of the invention, with a different type of robot that can also provide an extended stroke to reach an object without causing interference or clashing with a roof or other overhead structures when retracted. This robot has a rail 1 (X axis), which serves as support for pivoting beam 2 (at variable angle α) . The extension mechanism is attached to the pivoting beam (Z axis). By combining X, α and Z, any 3D point within the workspace of the robot can be addressed.

FIG. 17 and FIG. 18 are just examples of the numerous alternative embodiments that can be used to attain the objective of a robot or robotic structure that can reach any 3D point within its working space while providing a very long stroke without causing problems during retraction by using the retraction mechanism of the present invention.

Alternative embodiments of this actuator can also be deployed and retrieved pneumatically or hydraulically, with significant added complexity.

In other embodiments, other shapes can be used for the concentric bodies of the actuator (instead of cylinders). Actually, the first prototype we built and successfully tested was a set of rectangular tubes nested inside one another, that would slide relative to each other to deploy or retract the actuator. It worked very well, but the cylinders have some manufacturing and cost advantages, so the preferred embodiment depicted in FIGS. 15 and 16 is based on concentric cylinders. The material used for both the cylinders and the square tubes at the prototype stage was aluminum, but in mass production we envision the use of lighter materials, including molded or extruded plastics.

Another embodiment of the invention uses a scissor mechanism (instead of a set of concentric bodies) to deploy and retract a suction cup, gripper or other type of end-effector to grab the target object and lift it as needed. This approach works well too but has some added complexity.

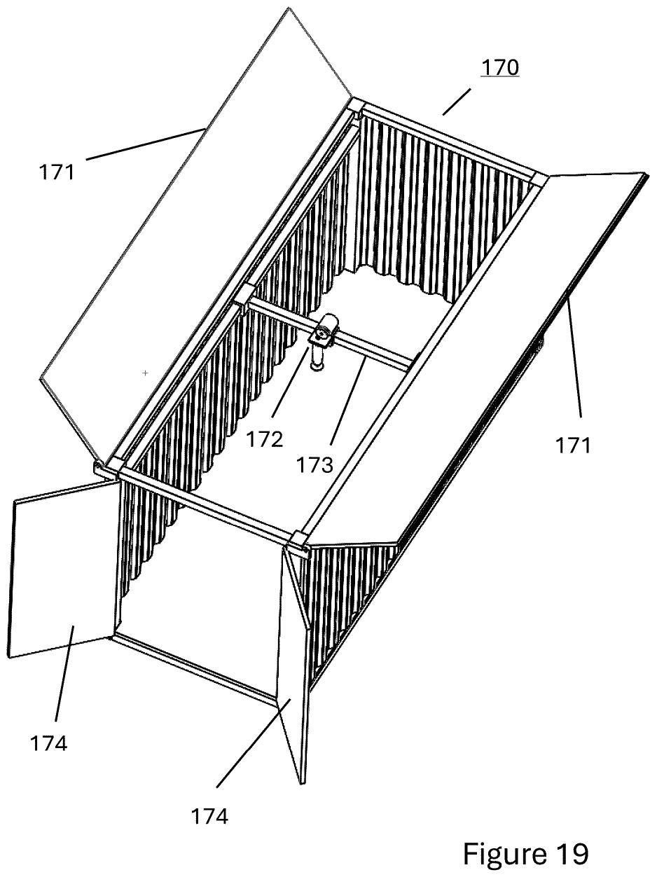

FIG. 19 is a top view of one of the preferred embodiments of the Robotic Container System (RCS) of the present invention, including:
Shipping container 170;
An optional double roof 171 that can be fully opened for overhead access to the inside of the container and can be folded down along the side walls of the container to keep the roof safely out of the way;
The new Cartesian Robot 172 equipped with the Extension System 173 with multiple deployable concentric cylinders, shown in this figure in retracted position; and
Optional double front doors 174.

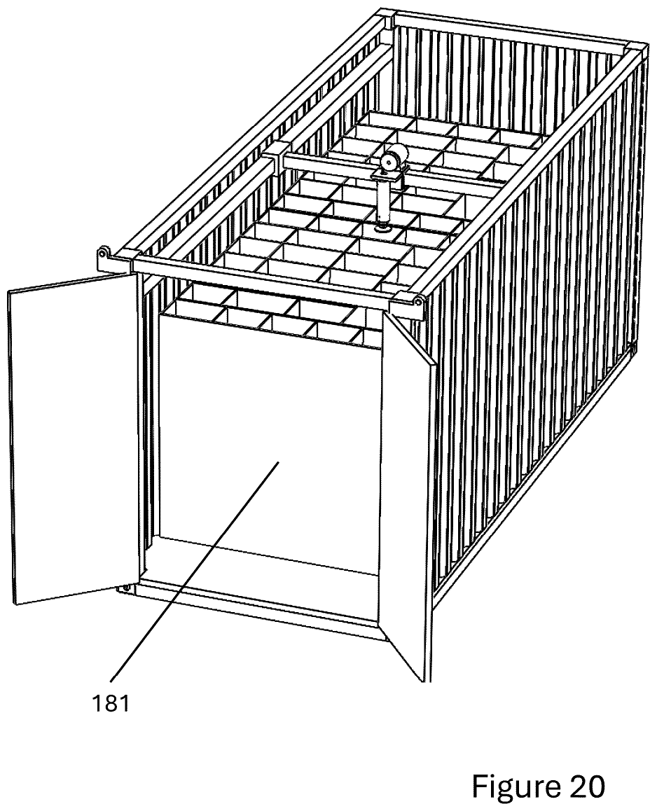

FIG. 20 shows the same preferred embodiment of the Robotic Container System (RCS) shown in FIG. 19, but with an additional key component: a set of partitions 181 that keeps the goods sorted and organized inside the container, based on multiple compartments with different standardized sizes, with the goods stacked up in the corresponding compartments in a desired sequence, such as reverse order (LIFO - last in, first out) of the expected future withdrawal sequence from the container. The Electronic Controller of the RCS, which may be attached to the inside of a container wall, records the full information about the container's cargo in its database and can instantaneously find the location of any object stored in the container at any time.

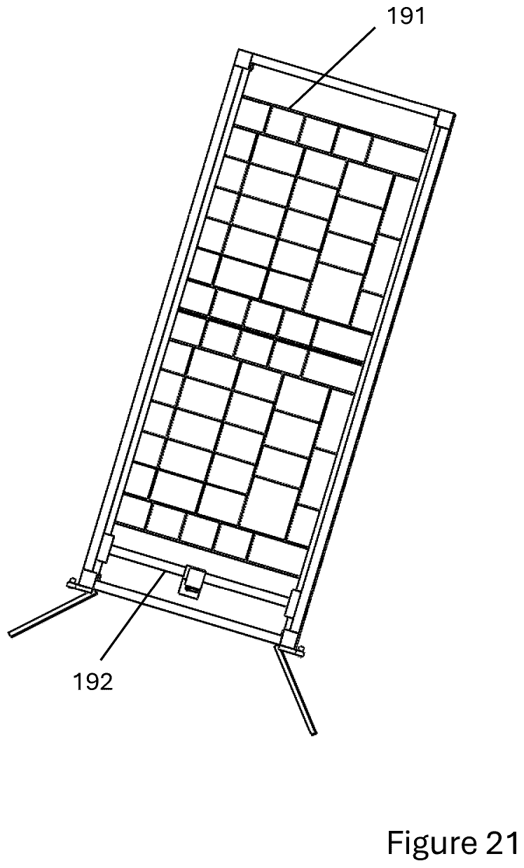

FIG. 21 is a top view of the Robotic Container System showing the set of partitions 191 providing multiple compartments with different standard sizes based on the size of the different goods to be stored in those compartments. The Extendable Cartesian Robot 192 hovers above the set of partitions and can be directed by the Electronic Controller to go to any location to pick up any desired object at any time.

The set of partitions is basically a matrix of rectangular cavities defined by long boards inside the container, running across the container from one wall of the container to the opposite wall, with multiple short boards perpendicular to the long boards located between the long boards or plates. The material of the boards or plates can be wood, plastic, metal (in which cases they would be called plates inside of boards) or other materials. The short boards and the long boards can be connected to each other with adhesive or fasteners or welding or other methods. The set of partitions can be fixed or dynamic. In a fixed set the location of the boards is permanently fixed. In a dynamic partition the location can be changed, which is achieved by providing grooves or channels that the boards are inserted into (without adhesives). The boards (or at least some of them) can be extracted and relocated to other grooves or channels, created partitions of a different size. The cavities between the boards are the compartments where the cargo will be inserted for storage inside the container. The cavities can have a rectangular shape, as described above, or any other desired shape. In a dynamic partition set the reconfiguration of the partitions can be done by human workers or by an external overhead robot operating through the open roof.

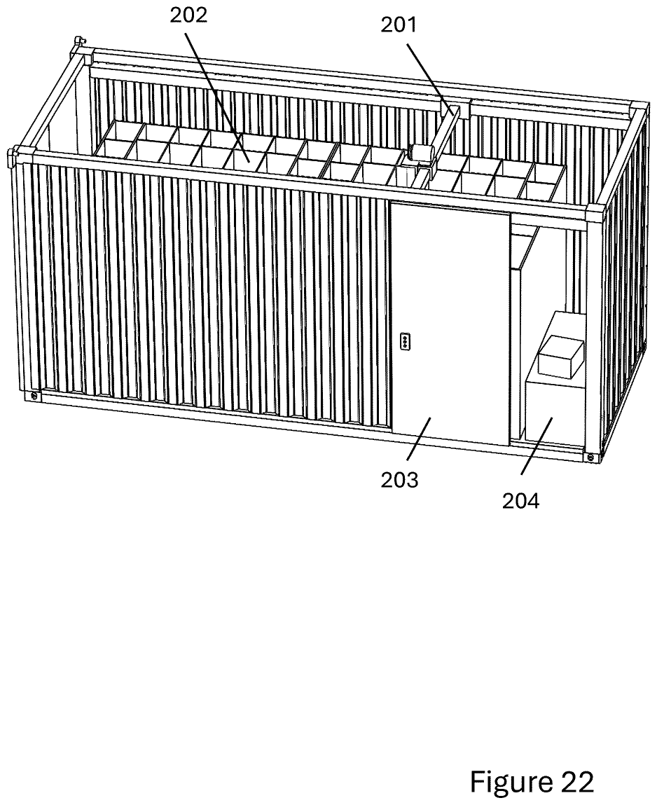

FIG. 22 shows a side view of the Robotic Container System, including its built-in Extendable Cartesian Robot 201, its internal partition set 202, and a sliding side door 203 to provide access to selected cargo picked by the cartesian robot and deposited on bench 204 for convenient pick up by a human worker or another external robot. This arrangement is very effective for warehouse operations, as well as for ecommerce delivery, where the driver or a drone or a mobile robot (wheeled or walking) could pick up the parts at the bench 204 and then carry them to the customer front door to drop them off.

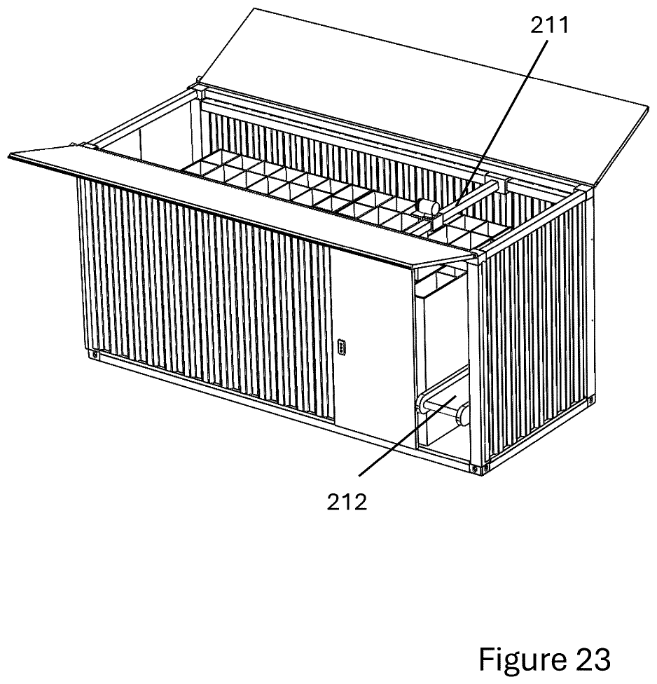

FIG. 23 shows a side view of another embodiment of the Robotic Container System (RCS) with an Extendable Cartesian Robot 211 that picks items from the cargo area of the container and deposits them on a dispensing conveyor belt 212 that makes the picked items conveniently available to outside personnel or other external robots.

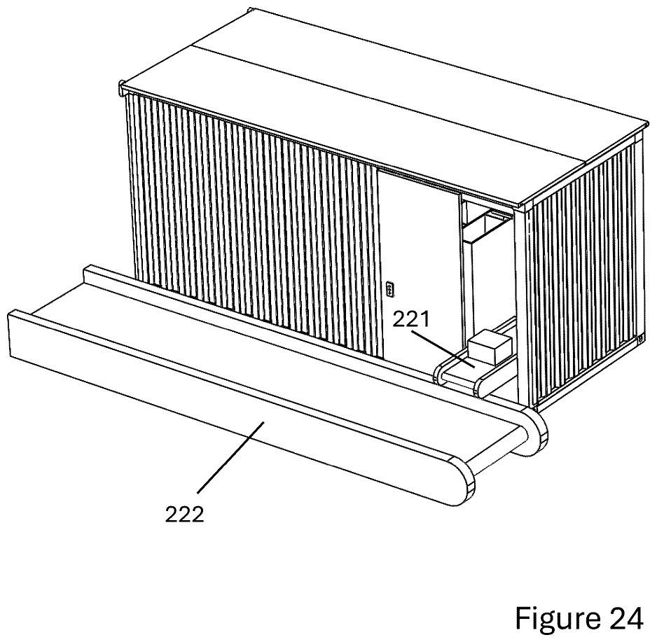

FIG. 24 shows another embodiment of the Robotic Container System (RCS) with a dispensing conveyor belt 221 which is mounted on a mobile base inside the container and therefore can move forward as needed and protrude out of the container in order to deliver the items picked by the Extendable Cartesian Robot to a warehouse conveyor belt 222, thereby integrating the smart active Container with the warehouse system or even directly with a production line.

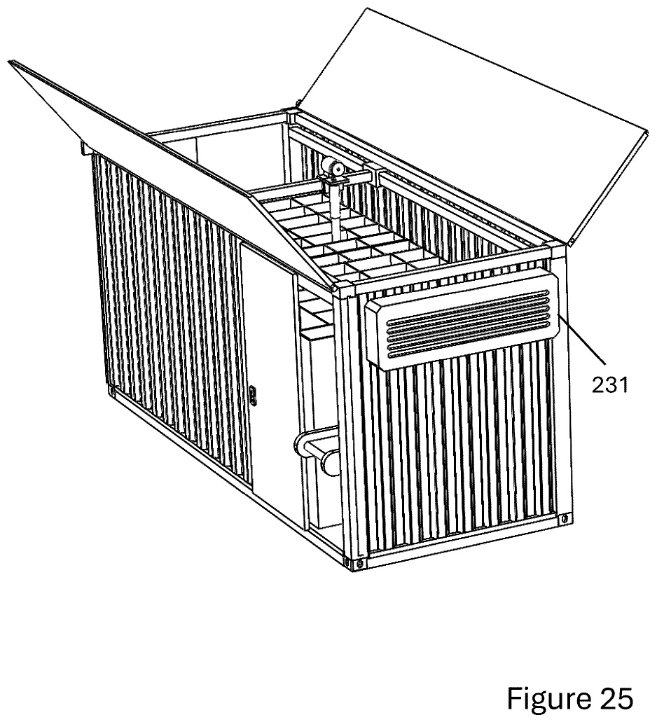

FIG. 25 shows another embodiment of the Robotic Container System (RCS) which is also equipped with a refrigeration unit 231 that enables the RCS for transportation of perishable products, such as pharmaceuticals, chemicals, food and beverage items and others, as well as the free or low cost e-commerce delivery of such items to customers on a large scale.

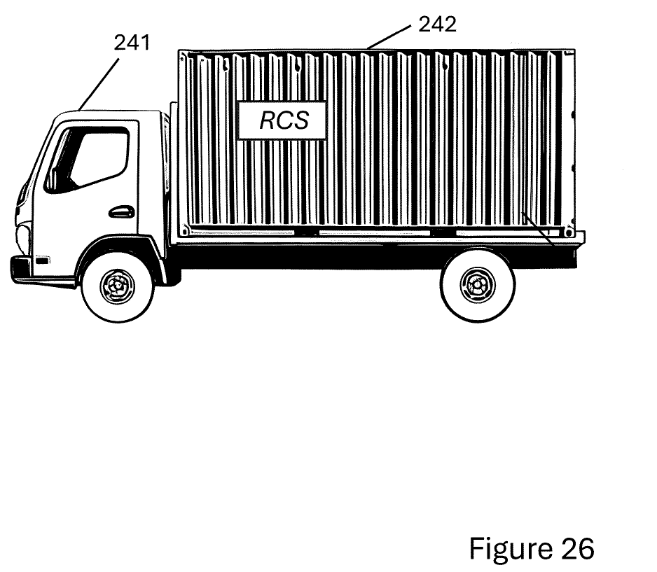

FIG. 26 shows another embodiment of the Robotic Container System (RCS), which consists of a flatbed truck 241 or similar vehicle carrying a smart active Container 242 with a built-in Extendable Cartesian Robot (not shown in this Figure), a configuration that is ideal for shipping cargo in general as well as for e-commerce delivery.

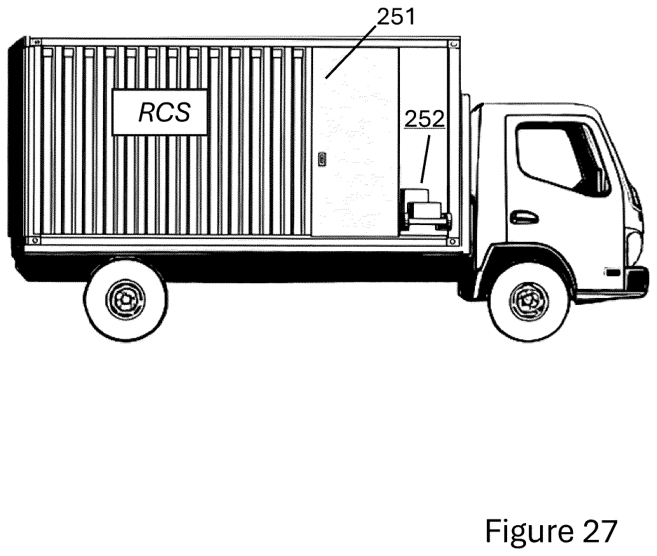

FIG. 27 shows the passenger side of the RCS flatbed truck, with an access door 251 and a built-in Extendable Cartesian Robot (not visible in this Figure) that can dispense picked objects 252 from the cargo area to outside personnel through said door 251, or in the case of e-commerce to the driver or to a delivery robot or drone to drop off at the customer door. This embodiment is highly suitable for general cargo transportation as well as for e-commerce delivery.

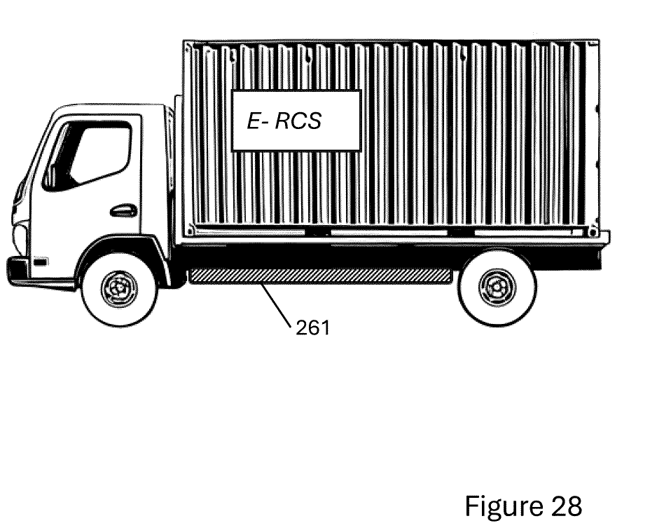

FIG. 28 shows the E-RCS, an electric-powered truck with a Robotic Container System. An ideal location for the battery pack 261 is underneath the truck, in the available and unused space that usually exists in flatbed trucks because the flatbed of the truck is by design located above the wheels, so that the cargo can be easily loaded without interference from wheels or wheel bays. This embodiment is highly suitable for general cargo transportation as well as for e-commerce delivery.

An ideal way to load the smart active containers of this invention with packages or any type of cargo is a Loading Cell, which is similar to a loading dock for smart containers. The Loading Cell typically includes a defined area of the warehouse where bins are brought in with the goods to be loaded into the container. The smart active container of this invention uses traction robots (or forklifts as a manual alternative) to position itself in a designated loading area and then opens its roof to be loaded from above by an overhead robot. If the container does not have an openable roof, it can still be loaded manually by a forklift or other equipment using the container's rear doors. The preferred embodiment has an automated motorized hinged roof, so that it can be easily, safely and quickly opened, which greatly facilitates automation and interaction with the warehouse/distribution center and maximizes efficiency.

The Loading Cell is equipped with at least two robots:
a light-duty robot for loading the containers with the goods, and
a heavy-duty duty overhead cartesian robot to lift the fully loaded container and transfer it through the air to a waiting truck.

The extension mechanism of this invention is optional for these two robots, as the need for it depends on the height Load Cell roof.

The light-duty overhead robot picks items from the bins and transfers them into the smart active container (in the correct route sequence if the container is intended for ecommerce delivery). A large sorting table is also available in the Loading Cell in case the need arises for the robot to re-sort goods or separate items with problems or other unusual issues. When the container is full, it closes its roof. The next task is to get the container on the waiting truck, and this can be done in three ways:
a) The heavy-duty overhead robot of the Load Cell can lift the complete loaded container and transfer it to the truck through the air. This is the fastest and most efficient way to do this task.
b) The traction robots get under the container, slightly lift and then carry the container to the loading dock or loading ramp of the Loading Cell, then move the container onto the truck and then go back to the Loading Cell to get another container. This is also an automated, very efficient and fast operation.
c) A human driver with a forklift can move the container onto the truck using the loading dock or loading ramp of the Load Cell.

While on route driving toward a home or business to deliver, the onboard robot in the smart active container finds and picks the items for the first delivery, so it will be ready to dispense them to the driver (or to a mobile drop-off robot or drone) upon arrival.

Another application of the robotized system of this invention is to have more than one internal overhead robot inside the container, especially in a long container. The container can be divided into different sections, each served by a different robot. The software can make the robots work as a team, for instance passing items from one robot to another and collectively moving the items toward the dispensing area.

Another advanced application that the Robotic Container System (RCS) of this invention makes possible is a fully automated delivery system for ecommerce and for general shipping. A self-driving truck can carry the smart, active container of this invention. Accordingly, the truck can take care of driving and road conditions, while the RCS can take care of the cargo. Actually, the RCS will be a critical enabler, because self-driving ecommerce makes sense if it is not necessary to take a human worker in the delivery truck to pick packages from the truck and walk them to the customer door. With a self-driving vehicle, the packages will be picked up and dispensed by the onboard robot to an external mobile robot or a drone to take them from the truck to the customer door. And self-driving vehicles is just a matter of time, it's a complex task but it will happen soon.

The above descriptions are intended for disclosure to individuals skilled in the art, and the descriptions include numerous embodiments with some specific features for the purpose of illustrating some exemplary applications of the invention, without intention of limiting this invention to those specific embodiments, features or descriptions. For example, many of the descriptions above refer to the Extendable Cartesian Robot, because that is a preferred embodiment, but of course many other alternative robots equipped with the extension mechanism of this invention are also possible, some of which are shown on FIG. 17 and FIG. 18.

Any individual skilled in the art would be able to use the teachings of the present disclosures and teachings to modify these embodiments or to conceive, design and develop new embodiments or variations of the disclosed embodiments based on said teachings, which would all fall within the scope of the present invention.

What is claimed:

1. A Robotic Container comprising
two side walls, a front wall, a rear wall, a floor and a roof, defined collectively as the enclosure;
front, rear and side doors as needed;
a set of parallel rails running inside the enclosure in the direction of axis X, defined as a direction from front to rear of the enclosure and parallel to the side walls of the enclosure, wherein the rails are mounted inside the enclosure in a position substantially parallel to the floor and at a height substantially close to the roof of the enclosure;
a bridge comprising a beam slidably mounted on the set of parallel rails in the direction of axis Y, defined as perpendicular to axis X;
a cartesian robot that is slidably mounted on the bridge, and is therefore able to move in both directions X and Y under the command of the processor, defined as the robot's computer;
an extendable arm, wherein:
the extendable arm can deploy downwards toward the floor of the container in the direction of axis Z, defined as a direction perpendicular to the plane formed by axis x and y, wherein the extendable arm can extend its length substantially in in excess of its retracted length; and
the extendable arm ensures by design that it can move only up and down in direction Z, at all times and at any length of deployment, and can never deflect sideways and get into a back-and-forth sideways swinging motion, thus maintaining safety of operation in all positions at all times.

2. The Robotic Container of claim 1, wherein the extendable arm is attached to the cartesian robot or any other suitable location substantially at bridge level, wherein:
the extendable arm consists of a set of concentric, nested tubes with a cross section comprising one of round, rectangular, square or any other suitable cross section;
wherein the nested tubes have dimensions that allow them to fit into one another with standard engineering tolerances consistent with sliding motion that allow the tubes to move axially relative to one another to deploy or retract the extendable arm only axially while preventing a back and forth swinging movement of the arm when the robotic container moves in transportation, thus enabling safe operation.

3. The Robotic Container of claim 1 which is equipped with an arm controller which may be integral with the cartesian robot or located substantially close to it, wherein the arm controller is a mechanism to control the amount and the speed of deployment and retraction of the extendable arm under the command of the processor, thus enabling the processor to position the end of the extendable arm to any desired location (X, Y, Z) substantially within the work envelope of the robot, defined as the 3D volume enclosed by the maximum values of the axes X, Y and Z.

4. The Robotic Container of claim 1, wherein the arm controller comprises:
one of the set comprising a flat belt, v-belt, timing belt, synchronous belt, toothed belt, rope, webbing, cable and other flexible power transmission element wound up around a machine rotary element from the set comprising a pulley, a wheel, a cylinder, a gear, a pinion and other rotary elements, with one end of the flexible power transmission element attached to the rotary element and the other end attached to the extendable arm; and
a torque source comprising an electric motor or any other suitable torque generating device that can turn the machine rotary element to deploy the extendable arm when turning in one rotational direction and retract it when turning in the opposite rotational direction.

5. The Robotic Container of claim 4, wherein the end of the flexible power transmission element of the arm controller is attached to the innermost nested body of the extendable arm, which occupies the lowest vertical position in the stack of nested bodies when the extendable arm is fully extended, thus making the innermost nested body the driver of the whole stack when starting downward deployment or ending upward retraction.

6. The Robotic Container of claim 1, which is equipped with an end-effector attached to the end of the extendable arm, said end-effector having the capability to attach itself to an object to be picked up by using one or more of the set comprising a vacuum device with one or more suction cups, a magnetic gripper for metal objects, a mechanical gripper based on one or more of contact, force, friction, stickiness, mechanical engagement and any other suitable gripping methods.

7. The Robotic Container of claim 1 which is based on one or more of the set comprising extendable and retractable scissor mechanisms, other mechanical deployment and retraction methods, hydraulic deployment and retraction, pneumatic deployment and retraction and other mechanisms to provide deployment and retraction.

8. The Robotic Container of claim 1, wherein a side door on the Container can be opened by a human operator or by the electronic controller/computer to pick up items picked by the cartesian robot and deposited on a bench or on a conveyor belt used as staging area for extracted packages that can be collected for drop=off by a member of the drop-off crew consisting of driver and robot drop-off assistants.

9. The Robotic Container of claim 1, further comprising aLoad Cell which is a portion of the warehouse or distribution Center equipped with automated loading robots and cartesian robots that can automatically load packages into cribs that are transported to the delivery vehicle with the assistance of tractive robots or a forklift or cranes.

10. The Robotic Container of claim 1, further comprising a fully electric delivery system for ecommerce with automated picking and dispensing of packages to the driver or mobile robot or drone, based on the Robotic Container of the present invention mounted on a truck, wherein the truck is powered by an electric powertrain and a battery pack ideally located under the flatbed.

11. The Robotic Container of claim 1, further comprising An Artificial Intelligence supported Logistic Management Software system that:
integrates the Robotic Container, including its cargo, into the inventory of the company, defining and utilizing the Robotic Container as an actionable, deployable and mobile warehouse item, that can be used to optimize and automate logistics, warehouse and distribution center operations; and
uses Artificial Intelligence algorithms and Machine Learning to efficiently manage the Robotic Container of this invention by optimizing important tasks in Logistics and e-commerce, such as finding the best delivery route, dynamically adjusting the delivery route, determining the best delivery point at destination, determining the best way to perform the last yard delivery to a home or business (by driver, by robot delivery assistant or by drone) and other key tasks.

12. A method of operating a Robotic Container mounted on one of a flatbed truck, a conventional truck, a van or other suitable delivery vehicle, said method comprising:
loading a plurality of packages to be delivered in the correct delivery sequence into a crib, defined as a box with an internal matrix of compartments to store the packages, wherein said loading operation is performed at high speed and with high accuracy by automated loading robots in the Load Cell, defined as a portion of the distribution center or warehouse assigned to this function;
electronically or otherwise transferring a copy of the cargo manifest of the crib, defined as a list of packages in the crib with shipping address and location for each package within the crib, to the processor of the Robotic Container assigned to that delivery;
physically transferring the crib from the Load Cell to the delivery vehicle using one from the set comprising a forklift and tractive robots and overhead crane and other suitable cargo moving equipment;
inserting the crib with the preloaded packages into the delivery vehicle through the rear door of the Robotic Container or through a top access door in the roof of the Container or a removable roof into the Robotic Container, wherein a much higher loading capacity can be achieved by the crib eliminating the need for aisles and racks, and increasing package density by enabling compact compartmentalized storage;
transporting the delivery container along a delivery route;
during transport, identifying a package corresponding to a next delivery destination based on delivery-sequence data;
extracting, by the inboard Cartesian Robot within the Container, the identified package from the crib while the vehicle is in motion;
transferring the extracted package to a staging area within the delivery container accessible through a side or rear access point; and
retrieving the package from the staging area for delivery at the delivery destination by a human driver or a robotic delivery assistant, the automated extraction and staging enabling operation of the delivery container in driver-assisted or driverless delivery modes.

13. A method of performing ecommerce last-mile package delivery, comprising:
loading a plurality of packages into a crib at a Load Center using automated loading robots or human workers, the packages being arranged in a delivery sequence and inserted into the crib;
inserting the loaded crib into the Robotic Container carried by a vehicle, the crib providing substantially higher package capacity relative to prior conventional delivery vans by eliminating the need for aisles and racks and enabling a substantially higher density through compact compartmentalized storage;
transporting the delivery container along a delivery route;
during transport, extracting, by the inboard Cartesian Robot within the delivery container, a package corresponding to an upcoming delivery stop and placing it in a staging area accessible to the drop-off crew through a convenient access door, the drop-off crew comprising the human driver and robotic drop-off assistants;
at the delivery stop, dropping off the staged package to a customer location by a human driver or a robotic delivery assistant normally waiting within the delivery container; and⋅ repeating the extracting and delivering steps for subsequent delivery stops along the route, the automated staging and robotic delivery capability enabling operation of the delivery container in driver-assisted or driverless delivery modes.
